(19) United States
(12) Patent Application Publication
(10) Pub. No.: US 2021/0309940 A1
(43) Pub. Date: Oct. 7, 2021

(54) Single Dose Detergent Packs With A Combination Of Non-Aqueous Solvents

(71) Applicant: Henkel IP & Holding GmbH, Duesseldorf (DE)

(72) Inventors: Wei Sun, Trumbull, CT (US); Daniel Thomas Piorkowski, Fairfield, CT (US); Napaporn Slattery, Monroe, CT (US); Kimberly Lockwood, New Milford, CT (US)

(73) Assignee: Henkel IP & Holding GmbH, Duesseldorf (DE)

(21) Appl. No.: 16/837,484

(22) Filed: Apr. 1, 2020

(51) Int. Cl. C11D 3/37; C11D 17/04; C11D 11/00; C11D 1/66; C11D 3/43

(52) U.S. Cl. CPC C11D 3/3707; C11D 17/043; C11D 11/0017; C11D 3/43; C11D 1/66; C11D 3/3723; C11D 11/0023

(57) ABSTRACT

A single dose pack includes a container composed of a water-soluble film and a wash composition encapsulated within the container. The wash composition includes a detergent surfactant, water present in an amount of from about 5 to about 40 weight percent, based on the total weight of the wash composition, a non-aqueous solvent including a combination of a polyethylene glycol (PEG) polymer having a weight average molecular weight of from about 200 Daltons to about 1,000 Daltons and a polyethyleneimine-ethoxylated (PEI-EO) polymer. The non-aqueous solvent combination of the PEG and PEI-EO polymers is present in an amount of from about 1 to about 15 weight percent, based on the total weight of the wash composition. Furthermore, a weight ratio of the PEG polymer to the PEI-EO polymer is from about 10:1 to about 1:10.

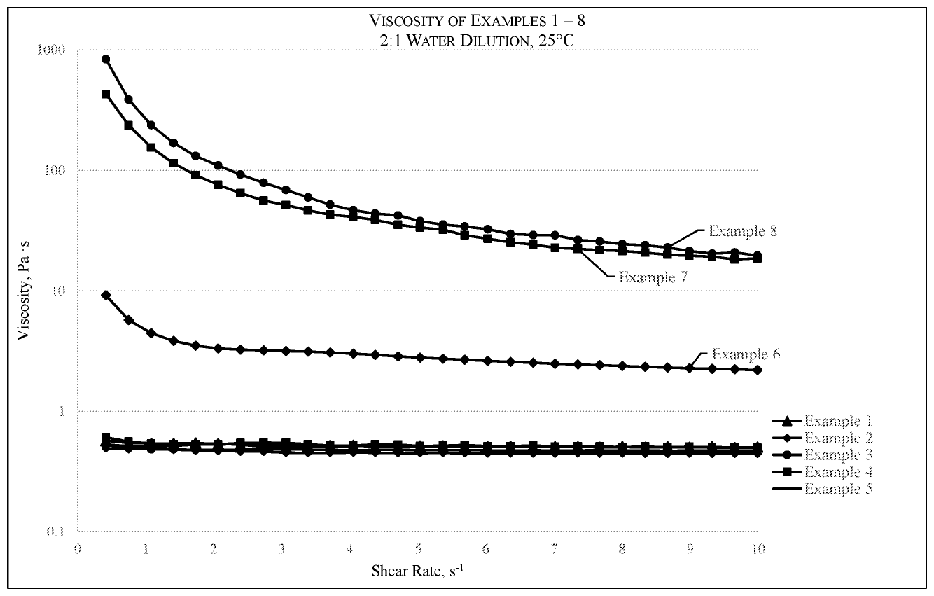

### FIELD OF THE INVENTION

The technical field generally relates to detergent packaged in single dose packs. More particularly, the technical field relates to single dose detergent packs with a combination of non-aqueous solvents that exhibit a relatively low viscosity and good dissolution in water.

### BACKGROUND OF THE INVENTION

Detergent packaged in single dose packs is available for a variety of washing activities, such as clothes laundering and dish washing. The single dose pack provides a pre-measured quantity of detergent that is easy to carry and convenient to use. The pre-measured liquid or “wash composition” packed in a water-soluble film eliminates the possibility of messiness or accidental spillage that consumers may have experienced when using conventional liquid detergent that is not pre-measured. Moreover, the single dose pack minimizes over-dosage of detergent and has proven popular with consumers.

A single dose pack often contains a more concentrated liquid surfactant composition as compared to conventional liquid detergent due to the smaller dose contained in the single dose pack. The higher total surfactant concentration in a single dose pack has caused challenges in terms of rheology control of the liquid wash composition. For example, it is desirable that the liquid wash composition not be excessively viscous, when diluted in water, such that it dissolves completely when exposed to wash water, thereby ensuring it is fully available for its intended washing use and also ensuring that it does not clog any tubes or pipes of the washing machine. In general, water-diluted viscosities, at dilution ratios of 2:1 (wash composition to water) or greater dilution, of less than about 1,000 centipoise (at 25° C.) are suitable for the liquid composition of a single dose pack. Therefore, a single dose pack liquid wash composition usually includes more non-aqueous solvents in order to solve this challenge and ensure a suitable viscosity. However, increasing the use of non-aqueous solvents undesirably reduces the volume available for other components of the liquid wash composition, such as additional surfactant, and further increases its expense.

Accordingly, it is desirable to provide a single dose pack with increased liquid surfactant concentration but that does not suffer from an excessively high viscosity. Additionally, it is desirable to provide such single dose packs that are able to minimize the inclusion of non-aqueous solvents while still achieving a suitable viscosity and solubility of the liquid wash composition. Furthermore, other desirable features and characteristics will become apparent from the subsequent detailed description and the appended claims, taken in conjunction with the accompanying drawings and the foregoing technical field and background.

### SUMMARY OF THE INVENTION

It has been discovered by the inventors that the inclusion of a combination of two particular non-aqueous solvents, namely (1) polyethylene glycol (PEG) polymer having a molecular weight (MW) in a range from about 200 to about 1000 Daltons and (2) polyethyleneimine-ethoxylated polymer, in the liquid detergent wash composition allows for the incorporation of less total non-aqueous solvent to achieve a suitable viscosity when diluted in water than if either solvent had been used individually. As such, an unexpected synergism has been discovered when using the PEG polymer in combination with the polyethyleneimine-ethoxylated polymer for viscosity reduction in single dose detergent systems including a relatively high concentration of detergent surfactant.

Accordingly, single dose packs and methods for producing and using the same are provided. In one exemplary embodiment, a single dose pack includes a container composed of a water-soluble film and a wash composition encapsulated within the container. The wash composition includes a detergent surfactant, water present in an amount of from about 5 to about 40 weight percent, based on the total weight of the wash composition, a non-aqueous solvent including a combination of a polyethylene glycol (PEG) polymer having a weight average molecular weight of from about 200 Daltons to about 1,000 Daltons and a polyethyleneimine-ethoxylated (PEI-EO) polymer. The non-aqueous solvent combination of the PEG and PEI-EO polymers is present in an amount of from about 1 to about 15 weight percent, based on the total weight of the wash composition. Furthermore, a weight ratio of the PEG polymer to the PEI-EO polymer is from about 10:1 to about 1:10.

### BRIEF DESCRIPTION OF THE DRAWING

The present disclosure will hereinafter be described in conjunction with the accompanying Drawing, which is a graph representing viscosity values as a function of shear rate for examples of 2:1 ratio diluted wash compositions in accordance with the present disclosure, along with such values for several comparative examples.

### DETAILED DESCRIPTION OF THE INVENTION

The following detailed description is merely exemplary in nature and is not intended to limit the disclosed single dose pack, or any associated methods for producing or using the same described herein. Furthermore, there is no intention to be bound by any theory presented in the preceding background or the following detailed description.

The term “about” as used in connection with a numerical value throughout the specification and the claims denotes an interval of accuracy, familiar and acceptable to a person skilled in the art. In general, such interval of accuracy is ±10%. Thus, “about ten” means 9 to 11. All numbers in this description indicating amounts, ratios of materials, physical properties of materials, and/or use are to be understood as modified by the word “about,” except as otherwise explicitly indicated.

The term “PEG” stands for polyethylene glycol. As conventionally used in the art, the use of PEG alone, not followed by a number, refers to PEG with all possible molecular weights (MW). The use of PEG with a specific number, for example, “PEG 400”, indicates PEG having a weight average molecular weight of about the specific number (i.e., 400), for example having weight average MW ranging from about 380 to about 420.

In accordance with various embodiments, a single dose pack is formed by encapsulating a wash composition within a container, where the container includes a film. In some embodiments, the film forms one half or more of the container, where the container may also include dyes, print, or other components in some embodiments. The film is water soluble such that the film will completely dissolve when an exterior of the film is exposed to water, such as in a washing machine typically used for laundry. When the film dissolves, the container is ruptured, and the contents are released. As used herein, “water soluble” means at least 2 grams of the solute (the film in one example) will dissolve in 5 liters of solvent (water in one example,) for a solubility of at least 0.4 grams per liter (g/l), at a temperature of 25 degrees Celsius (° C.) unless otherwise specified. Suitable films for packaging are completely soluble in water at temperatures of about 5° C. or greater.

The film is desirably strong, flexible, shock resistant, and non-tacky during storage at both high and low temperatures and high and low humidity. In an exemplary embodiment, the film is initially formed from polyvinyl acetate, and at least a portion of the acetate functional groups are hydrolyzed to produce alcohol groups. Therefore, the film includes polyvinyl alcohol (PVOH), and may include a higher concentration of PVOH than polyvinyl acetate. Such films are commercially available with various levels of hydrolysis, and thus various concentrations of PVOH, and in an exemplary embodiment the film initially has about 85 percent of the acetate groups hydrolyzed to alcohol groups. Some of the acetate groups may further hydrolyze in use, so the final concentration of alcohol groups may be higher than the concentration at the time of packaging. The film may have a thickness of from about 25 to about 200 microns (μm), or from about 45 to about 100 μm, or from about 75 to about 90 μm in various embodiments. The film may include alternate materials in some embodiments, such as methyl hydroxy propyl cellulose and polyethylene oxide, but the film is water soluble in all embodiments.

The single dose pack may be formed from a container having a single compartment, but the single dose pack may be formed from containers with two or more different compartments in alternate embodiments. In embodiments with a container having two or more compartments, the contents of the different compartments may or may not the same. In some embodiments, the single dose pack is formulated and configured for cleaning laundry, but other cleaning purposes are also possible. The wash composition is positioned within the container, and the container is sealed to encase and enclose the wash composition. The wash composition is typically in direct contact with the film of the container within the single dose pack. The film of the container is sealable by heat, heat and water, ultrasonic methods, or other techniques, and one or more sealing techniques may be used to enclose the wash composition within the container.

In an exemplary embodiment, the wash composition is liquid when encapsulated within the container. As initially noted, it is desirable that the viscosity of the liquid wash composition, when diluted with water (at wash composition to water ratios of about 2:1, or greater dilution) not be excessive, such that the liquid composition is able to fully dissolve in wash water, and further that it does not cause any problems in terms of operation of the washing machine. “Viscosity” as used herein, means the viscosity measured by a rotational viscometer at a temperature of 25 degrees Celsius (° C.). Accordingly, the as-diluted wash compositions in accordance with the present disclosure have a viscosity of 1,000 centipoise or less, such as from about 50 to about 1,000 centipoise, or from about 50 to about 800 centipoise, or from about 50 to about 600 centipoise. Within this viscosity range, the liquid form facilitates rapid delivery and dispersion of the wash composition once the container ruptures, and this rapid dispersion can aid cleaning.

In an exemplary embodiment, the single dose pack is sized to provide a desired quantity of wash composition for one load of laundry or one batch of dishes in a dishwasher. The single dose pack may also be sized for a fraction of a desired quantity, such as one half of a load of laundry, so a user can adjust the amount of detergent added without having to split a single dose pack. In an exemplary embodiment, the single dose pack has a weight of from about 15 to about 50 grams. In alternate embodiments, the single dose pack is from about 15 to about 40 grams, or from about 17 to about 30 grams.

A plurality of components are combined to form a wash composition, where the wash composition is typically prepared prior to encapsulating within the container. However, in some embodiments, the components of the wash composition may be enclosed in different compartments of a multi-compartment single dose packs and all the components are released simultaneously or consecutively upon use. The film remains structurally sound and intact prior to use of the single dose pack, where the single dose pack is immersed in a large quantity of water in use. A “large” quantity of water is at least about 100 times the weight of the single dose pack. For example, a single dose pack having a weight of from about 5 to about 50 grams may be immersed in from about 5 to about 50 liters of water in use. As used herein, “structurally sound” means the container and the film do not rupture or leak under typical storage conditions, such as about 0.5 to about 1.5 atmospheres of pressure, temperatures of about −10 to about 35° C., and a relative humidity of about 1 to about 80% for a period of at least 1 week. Structurally sound also means the container and the film are not tacky or sticky to the touch.

In accordance with the present disclosure, the wash composition includes a synergistic combination of two non-aqueous solvents. As initially noted above, it has been discovered that the inclusion of a combination of polyethylene glycol (PEG) polymer (having a molecular weight (MW) in a range from about 200 to about 1000 Daltons) and polyethyleneimine-ethoxylated (PEI-EO) polymer in the liquid detergent wash composition allows for the incorporation of less total non-aqueous solvent to achieve a suitable viscosity than if either solvent had been used individually. As such, using the PEG polymer in combination with the polyethyleneimine-ethoxylated polymer allows for viscosity reduction in single dose detergent systems including a relatively high concentration of detergent surfactant.

The PEG used in accordance with the present disclosure may have a weight average MW from about 200 Daltons to about 1000 Daltons, for example from about 300 Daltons to about 900 Daltons, or about 300 Daltons to about 800 Daltons, or about 300 Daltons to about 600 Daltons. Alternatively, the PEG may have a weight average MW from about 200 Daltons to about 500 Daltons, or from about 300 Daltons to about 600 Daltons. In a particular embodiment, PEG 400 is included.

The polyethyleneimine-ethoxylated polymer used in accordance with the present disclosure may include a polyethyleneimine backbone that has a weight average molecular weight of from about 400 Daltons to about 10,000 Daltons, for example from about 400 Daltons to about 6,000 Daltons, such as from about 400 Daltons to about 1,800 Daltons. The substitution of the polyethyleneimine backbone may include one or two ethoxylation modifications per nitrogen atom, dependent on whether the modification occurs at an internal nitrogen atom or at a terminal nitrogen atom in the polyethyleneimine backbone. The ethoxylation modification may consists of the replacement of a hydrogen atom by a polyoxyethylene chain having an average of about 40 to about 90 ethoxy units per modification, for example about 45 to about 80 ethoxy units, such as about 50 to about 80 ethoxy units. In one exemplary embodiment, the polyethyleneimine-ethoxylated polymer used in accordance with the present disclosure is the commercially-available Sokalan® HP 20 (BASF SE).

The non-aqueous solvent combination of the PEG polymer and the polyethyleneimine-ethoxylated polymer may be described in terms of a weight ratio with respect to one another. For example, in various embodiments, the non-aqueous solvent combination may be provided in a weight ratio of the PEG polymer to the polyethyleneimine-ethoxylated polymer of about 10:1 to about 1:10, for example from about 8:1 to about 1:8, or about 5:1 to about 1:5, or about 3:1 to about 1:3, or about 2:1 to about 1:2, or about 1:1. In other embodiments, this weight ratio may be from about 10:1 to about 1:5, from about 5:1 to about 1:2, from about 1:2 to about 5:1, or from about 1:2 to about 10:1.

The non-aqueous solvent combination of the PEG polymer and the polyethyleneimine-ethoxylated polymer in accordance with any of the foregoing embodiments may be included in the wash composition at amounts of from about 1 to about 15 weight percent, or from about 2 to about 13 weight percent, or from about 3 to about 10 weight percent, or from about 4 to about 8 weight percent, in various embodiments, based on the total weight of the wash composition. In other embodiments, the non-aqueous solvent combination is present in an amount of from about 2 to about 4 weight percent, or from about 4 to about 6 weight percent, or from about 6 to about 8 weight percent, based on the total weight of the wash composition.

Besides the non-aqueous solvent combination of the PEG and PEI-EO polymers described above, the wash composition may optionally include other non-aqueous solvents. For example, other non-aqueous solvents that may be included in the wash composition are glycerol, propylene glycol, ethylene glycol, ethanol, and 4C+ compounds. The term “4C+ compound” refers to one or more of: polypropylene glycol; polyethylene glycol esters such as polyethylene glycol stearate, propylene glycol laurate, and/or propylene glycol palmitate; methyl ester ethoxylate; diethylene glycol; dipropylene glycol; sorbitol; tetramethylene glycol; butylene glycol; pentanediol; hexylene glycol; heptylene glycol; octylene glycol; 2-methyl, 1,3 propanediol; xylitol; mannitol; erythritol; dulcitol; inositol; adonitol; triethylene glycol; polypropylene glycol; glycol ethers, such as ethylene glycol monobutyl ether, diethylene glycol monobutyl ether, triethylene glycol monobutyl ether, ethylene glycol monopropyl ether, diethylene glycol monoethyl ether, triethylene glycol monoethyl ether, diethylene glycol monomethyl ether, and triethylene glycol monomethyl ether; tris (2-hydroxyethyl)methyl ammonium methylsulfate; ethylene oxide/propylene oxide copolymers with a number average molecular weight of 3,500 Daltons or less; and ethoxylated fatty acids. These optional non-aqueous solvents may be included in amounts, individually, of anywhere from about 1 weight percent to about 30 weight percent.

The wash composition may include other components as well. For example, water is included in the wash composition. In some embodiments, water is present in an amount of from about 5 to about 40 weight percent, from about 8 to about 30 weight percent, from about 10 to about 25 weight percent, or from about 12 to about 20 weight percent. In other embodiments, water is present in an amount of from about 5 to about 8 weight percent, from about 8 to about 11 weight percent, from about 11 to about 15 weight percent, or from about 15 to about 20 weight percent. Water may be added to the wash composition directly or as a component of other ingredients, or directly and as a component of other ingredients.

Furthermore, the wash composition includes one or more detergent surfactants. In some embodiments, the wash composition may include an ionic detergent surfactant, where the ionic detergent surfactant is formulated for laundry in an exemplary embodiment. The ionic detergent surfactant may include one or more surfactants, including cationic and/or anionic surfactants, in various embodiments. The ionic detergent surfactant may be present in the wash composition at a concentration of from about 5 to about 55 weight percent in one embodiment, but the ionic detergent surfactant may be present in the wash composition at a concentration of about 10 to about 30 weight percent or from about 20 to about 25 weight percent in alternate embodiments, where weight percentages are based on a total weight of the wash composition.

Suitable ionic detergent surfactants that are anionic include soaps which contain sulfate or sulfonate groups, including those with alkali metal ions as cations. Usable soaps include alkali metal salts of saturated or unsaturated fatty acids with 12 to 18 carbon (C) atoms. Such fatty acids may also be used in incompletely neutralized form. Usable ionic detergent surfactants of the sulfate type include the salts of sulfuric acid semi esters of fatty alcohols with 12 to 18 C atoms, and/or alcohol ethoxysulfates. Usable ionic detergent surfactants of the sulfonate type include alkane sulfonates with 12 to 18 C atoms and olefin sulfonates with 12 to 18 C atoms, such as those that arise from the reaction of corresponding mono-olefins with sulfur trioxide, alpha-sulfofatty acid esters such as those that arise from the sulfonation of fatty acid methyl or ethyl esters, and lauryl ether sulfates.

Suitable ionic detergent surfactants that are cationic may include textile-softening substances of the general formula X, XI, or XII as illustrated below:

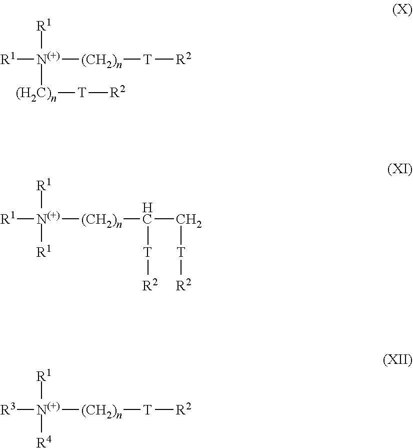

in which each R¹ group is mutually independently selected from among C₁₋₆ alkyl, alkenyl or hydroxyalkyl groups; each R² group is mutually independently selected from among C₈₋₂₈ alkyl or alkenyl groups; R³═R¹ or (CH₂)ₙ-T-R²; R⁴═R¹ or R² or (CH₂)ₙ-T-R²; T=-CH₂—, —O—CO—, or —CO—O—, and n is an integer from 0 to 5. The ionic detergent surfactants that are cationic may include conventional anions of a nature and number required for charge balancing. Alternatively, the ionic detergent surfactant may include anionic detergent surfactants that may function to balance the charges with the cationic detergent surfactants. In some embodiments, ionic detergent surfactants that are cations may include hydroxyalkyltrialkylammonium compounds, such as C₁₂₋₁₈ alkyl(hydroxyethyl)dimethyl ammonium compounds, and may include the halides thereof, such as chlorides or other halides. The ionic detergent surfactants that are cations may be especially useful for compositions intended for treating textiles.

In some embodiments, the anionic surfactant is a polyethoxylated alcohol sulfate, such as those sold under the trade name CALFOAM® 303 (Pilot Chemical Company, California). Such materials, also known as alkyl ether sulfates (AES) or alkyl polyethoxylate sulfates, are those which correspond to the following formula (XIII):

R′—O—(C2H4O)n-SO3M′ (XIII)

wherein R′ is a C8-C20 alkyl group, n is from 1 to 20, and M′ is a salt-forming cation, preferably, R′ is C10-C18 alkyl, n is from 1 to 15, and M′ is sodium, potassium, ammonium, alkylammonium, or alkanolammonium. In another embodiment, R′ is a C12-C16 alkyl, n is from 1 to 6 and M′ is sodium. In another embodiment, the alkyl ether sulfate is sodium lauryl ether sulphate (SLES).

In some embodiments, the anionic surfactant can be linear alkylbenzene sulfonic acid (LAS) or a salt thereof, alkyl propoxy sulphate, alkyl sulphate, or a mixture thereof. Linear alkylbenzenesulfonate (LAS) is a water soluble salt of a linear alkyl benzene sulfonate having between 8 and 22 carbon atoms of the linear alkyl group. The salt can be an alkali metal salt, or an ammonium, alkylammonium, or alkanolammonium salt. In one embodiment, the LAS comprises an alkali metal salt of C₁₀-C₁₆ alkyl benzene sulfonic acids, such as C₁₁-C₁₄ alkyl benzene sulfonic acids.

However, in other embodiments, the liquid compositions are substantially free of LAS. In other embodiments, the liquid compositions are substantially free of a sulfate surfactant.

Additionally, nonionic detergent surfactants may optionally be present in the wash composition at a concentration of from about 0 to about 60 weight percent, or from about 5 to about 50 weight percent, or from about 10 to about 30 weight percent, or from about 20 to about 40 weight percent in various embodiments. Suitable nonionic detergent surfactants include alkyl glycosides and ethoxylation and/or propoxylation products of alkyl glycosides or linear or branched alcohols in each case having 12 to 18 C atoms in the alkyl moiety and 3 to 20, or 4 to 10, alkyl ether groups. Corresponding ethoxylation and/or propoxylation products of N-alkylamines, vicinal diols, fatty acid esters and fatty acid amides, which correspond to the alkyl moiety in the stated long-chain alcohol derivatives, may furthermore be used. Alkylphenols having 5 to 12 C atoms may also be used in the alkyl moiety of the above described long-chain alcohol derivatives.

Examples of nonionic surfactants suitable for the present invention include, but are not limited to, polyalkoxylated alkanolamides, polyoxyalkylene alkyl ethers, polyoxyalkylene alkylphenyl ethers, polyoxyalkylene sorbitan fatty acid esters, polyoxyalkylene sorbitol fatty acid esters, polyoxyethylene polyoxypropylene alkyl ethers, polyoxyalkylene castor oils, polyoxyalkylene alkylamines, glycerol fatty acid esters, alkylglucosamides, alkylglucosides, alkylamine oxides, amine oxide surfactants, alkoxylated fatty alcohols, or a mixture thereof. In some embodiments, the nonionic surfactant is alcohol ethoxylate (AE), alcohol propoxylate, or a mixture thereof. In other embodiments, the nonionic surfactant is AE.

The AE may be primary and secondary alcohol ethoxylates, especially the C₈-C₂₀ aliphatic alcohols ethoxylated with an average of from 1 to 20 moles of ethylene oxide per mole of alcohol, and more especially the C₁₀-C₁₅ primary and secondary aliphatic alcohols ethoxylated with an average of from 1 to 10 moles, or from 3 to 8 moles of ethylene oxide per mole of alcohol.

Exemplary AEs are the condensation products of aliphatic C₈-C₂₀, preferably C₈-C₁₆, primary or secondary, linear or branched chain alcohols with ethylene oxide. In some embodiments, the alcohol ethoxylates contain 1 to 20, or 3 to 8 ethylene oxide groups, and may optionally be end-capped by a hydroxylated alkyl group.

In one embodiment, the AE has Formula (XIV):

R₂—(—O—C₂H₄—)ₘ—OH (XIV)

wherein R₂ is a hydrocarbyl group having 8 to 16 carbon atoms, 8 to 14 carbon atoms, 8 to 12 carbon atoms, or 8 to 10 carbon atoms; and m is from 1 to 20, or 3 to 8.

The hydrocarbyl group may be linear or branched, and saturated or unsaturated. In some embodiments, R₂ is a linear or branched C₈-C₁₆ alkyl or a linear group or branched C₈-C₁₆ alkenyl group. Preferably, R₂ is a linear or branched C₈-C₁₆ alkyl, C₈-C₁₄ alkyl, or C₈-C₁₀ alkyl group. In case (e.g., commercially available materials) where materials contain a range of carbon chain lengths, these carbon numbers represent an average. The alcohol may be derived from natural or synthetic feedstock. In one embodiment, the alcohol feedstock is coconut, containing predominantly C₁₂-C₁₄ alcohol, and oxo C₁₂-C₁₅ alcohols.

One suitable AE is Tomadol® 25-7 (available from Air Product). Other suitable AEs include Genapol® C200 (available from Clariant), which is a coco alcohol having an average degree of ethoxylation of 20.

Several other components may optionally be added to and included in the wash composition, including but not limited to enzymes, peroxy compounds, bleach activators, anti-redeposition agents, neutralizers, optical brighteners, foam inhibitors, chelators, bittering agents, dye transfer inhibitors, soil release agents, water softeners, and other components. A partial, non-exclusive list of additional components (not illustrated) that may be added to and included in the wash composition include electrolytes, pH regulators, graying inhibitors, anti-crease components, bleach agents, colorants, scents, processing aids, antimicrobial agents, and preservatives.

Possible enzymes that may be in the wash composition contemplated herein include one or more of a protease, lipase, cutinase, amylase, carbohydrase, cellulase, pectinase, mannanase, arabinase, galactanase, xylanase, oxidase, (e.g., a laccase), and/or peroxidase, but others are also possible. In general, the properties of the selected enzyme(s) should be compatible with the selected wash composition, (i.e., pH-optimum, compatibility with other enzymatic and non-enzymatic ingredients, etc.). The detergent enzyme(s) may be included in the wash composition by adding separate additives containing one or more enzymes, or by adding a combined additive comprising all the enzymes that are added to the wash composition. The enzyme(s) should be present in the wash composition in effective amounts, such as from about 0 weight percent to about 5 weight percent of enzyme, or from about 0.001 to about 1 weight percent, or from about 0.2 to about 2 weight percent, or from about 0.5 to about 1 weight percent, based on the total weight of the wash composition, in various embodiments.

As alluded to above, a peroxy compound may optionally be present in the wash composition. Exemplary peroxy compounds include organic peracids or peracidic salts of organic acids, such as phthalimidopercaproic acid, perbenzoic acid or salts of diperdodecanedioic acid, hydrogen peroxide and inorganic salts that release hydrogen peroxide under the washing conditions, such as perborate, percarbonate and/or persilicate. Hydrogen peroxide may also be produced with the assistance of an enzymatic system, i.e. an oxidase and its substrate. Other possible peroxy compounds include alkali metal percarbonates, alkali metal perborate monohydrates, alkali metal perborate tetrahydrates or hydrogen peroxide. Peroxy compounds may be present in the wash composition at an amount of from about 0 to about 50 weight percent, or an amount of from about 3 to about 30 weight percent, or an amount of from about 3 to about 10 weight percent, based on the total weight of the wash composition, in various embodiments.

Bleach activators may optionally be added and included in the wash composition. Conventional bleach activators that form peroxycarboxylic acid or peroxyimidic acids under perhydrolysis conditions and/or conventional bleach-activating transition metal complexes may be used. The bleach activator optionally present may include, but is not limited to, one or more of: N- or O-acyl compounds, for example polyacylated alkylenediamines, such as tetraacetylethylenediamine; acylated glycolurils, such as tetraacetylglycoluril; N-acylated hydantoins; hydrazides; triazoles; urazoles; diketopiperazines; sulfurylamides and cyanurates; carboxylic anhydrides, such as phthalic anhydride; carboxylic acid esters, such as sodium isononanoylphenolsulfonate; acylated sugar derivatives, such as pentaacetyl glucose; and cationic nitrile derivatives such as trimethylammonium acetonitrile salts.

To avoid interaction with peroxy compounds during storage, the bleach activators may be coated with shell substances or granulated prior to addition to the wash composition, in a known manner. As such, the bleach activator and/or other components may be present in a liquid wash composition as a free or floating particulate. Exemplary embodiments of the coating or shell substance include tetraacetylethylenediamine granulated with the assistance of carboxymethylcellulose and having an average grain size of 0.01 mm to 0.8 mm, granulated 1,5-diacetyl-2,4-dioxohexahydro-1,3,5-triazine, and/or trialkylammonium acetonitrile formulated in particulate form. In alternative embodiments, the bleach activators may be enclosed in a compartment, separate from the compartment that contains peroxy compounds and/or other compounds of the wash composition. In various embodiments, the bleach activators may be present in the wash composition in quantities of from about 0 to about 8 weight percent, or from about 0 to about 6 weight percent, or from about 0 to about 4 weight percent, in each case relative to the total weight of the wash composition.

One or more anti-redeposition agents may also be optionally included in the wash composition. Anti-redeposition agents include polymers with a soil detachment capacity, which are also known as “soil repellents” due to their ability to provide a soil-repelling finish on the treated surface, such as a fiber. Anti-redeposition agents include polymers with a soil detachment capacity. One example in regard to polyesters includes copolyesters prepared from dicarboxylic acids, such as adipic acid, phthalic acid or terephthalic acid. In an exemplary embodiment, an anti-redeposition agents includes polyesters with a soil detachment capacity that include those compounds which, in formal terms, are obtainable by esterifying two monomer moieties, the first monomer being a dicarboxylic acid HOOC-Ph-COOH and the second monomer a diol HO—(CHR¹¹-)aOH, which may also be present as a polymeric diol H—(O—(CHR¹¹-)ₐ)_{b}OH. Ph here means an ortho-, meta- or para-phenylene residue that may bear 1 to 4 substituents selected from alkyl residues with 1 to 22 C atoms, sulfonic acid groups, carboxyl groups and mixtures thereof. R¹¹ means hydrogen or an alkyl residue with 1 to 22 C atoms and mixtures thereof. “a” means a number from 2 to 6 and “b” means a number from 1 to 300. The polyesters obtainable therefrom may contain not only monomer diol units —O—(CHR¹¹—)ₙO— but also polymer diol units —(O—(CHR¹¹—)ₐ)_{b}O—. The molar ratio of monomer diol units to polymer diol units may amount to from about 100:1 to about 1:100, or from about 10:1 to about 1:10 in another embodiment. In the polymer diol units, the degree of polymerization “b” may be in the range of from about 4 to about 200, or from about 12 to about 140 in an alternate embodiment. The average molecular weight of the polyesters with a soil detachment capacity may be in the range of from about 250 to about 100,000, or from about 500 to about 50,000 in an alternate embodiment. The acid on which the residue Ph is based may be selected from terephthalic acid, isophthalic acid, phthalic acid, trimellitic acid, mellitic acid, the isomers of sulfophthalic acid, sulfoisophthalic acid and sulfoterephthalic acid and mixtures thereof. Where the acid groups thereof are not part of the ester bond in the polymer, they may be present in salt form, such as an alkali metal or ammonium salt. Exemplary embodiments include sodium and potassium salts.

If desired, instead of the monomer HOOC-Ph-COOH, the polyester with a soil detachment capacity (the anti-redeposition agent) may include small proportions, such as no more than about 10 mole percent relative to the proportion of Ph with the above-stated meaning, of other acids that include at least two carboxyl groups. These include, for example, alkylene and alkenylene dicarboxylic acids such as malonic acid, succinic acid, fumaric acid, maleic acid, glutaric acid, adipic acid, pimelic acid, suberic acid, azelaic acid and sebacic acid. Exemplary diols HO—(CHR¹¹—)ₐOH include those in which R¹¹ is hydrogen and “a” is a number of from about 2 to about 6, and in another embodiment includes those in which “a” has the value of 2 and R¹¹ is selected from hydrogen and alkyl residues with 1 to 10 C atoms, or where R¹¹ is selected from hydrogen and alkyl residues with 1 to 3 C atoms in another embodiment. Examples of diol components are ethylene glycol, 1,2-propylene glycol, 1,3-propylene glycol, 1,4-butanediol, 1,5-pentanediol, 1,6-hexanediol, 1,8-octanediol, 1,2-decanediol, 1,2-dodecanediol and neopentyl glycol. The polymeric diols include polyethylene glycol with an average molar mass in the range from about 1000 to about 6000. If desired, these polyesters may also be end group-terminated, with end groups that may be alkyl groups with 1 to 22 C atoms or esters of monocarboxylic acids. The end groups attached via ester bonds may be based on alkyl, alkenyl and aryl monocarboxylic acids with 5 to 32 C atoms, or with 5 to 18 C atoms in another embodiment. These include valeric acid, caproic acid, enanthic acid, caprylic acid, pelargonic acid, capric acid, undecanoic acid, undecenoic acid, lauric acid, lauroleic acid, tridecanoic acid, myristic acid, myristoleic acid, pentadecanoic acid, palmitic acid, stearic acid, petroselinic acid, petroselaidic acid, oleic acid, linoleic acid, linolaidic acid, linolenic acid, eleostearic acid, arachidic acid, gadoleic acid, arachidonic acid, behenic acid, erucic acid, brassidic acid, clupanodonic acid, lignoceric acid, cerotic acid, melissic acid, benzoic acid, which may bear 1 to 5 substituents having a total of up to 25 C atoms, or 1 to 12 C atoms in another embodiment, for example tert-butylbenzoic acid. The end groups may also be based on hydroxymonocarboxylic acids with 5 to 22 C atoms, which for example include hydroxyvaleric acid, hydroxycaproic acid, ricinoleic acid, the hydrogenation product thereof, hydroxystearic acid, and ortho-, meta- and para-hydroxybenzoic acid. The hydroxymonocarboxylic acids may in turn be joined to one another via their hydroxyl group and their carboxyl group and thus be repeatedly present in an end group. The number of hydroxymonocarboxylic acid units per end group, i.e. their degree of oligomerization, may be in the range of from 1 to 50, or in the range of from 1 to 10 in another embodiment. In an exemplary embodiment, polymers of ethylene terephthalate and polyethylene oxide terephthalate, in which the polyethylene glycol units have molar weights of from about 750 to about 5000 and the molar ratio of ethylene terephthalate to polyethylene oxide terephthalate of from about 50:50 to about 90:10, are used alone or in combination with cellulose derivatives. The anti-redeposition agent is present in the wash composition at an amount of from about 0 to about 3 weight percent, or an amount of from about 0 to about 2 weight percent, or an amount of from about 0 to about 1 weight percent, based on the total weight of the wash composition, in various embodiments.

Neutralizers are optionally added to and included in the wash composition. Exemplary neutralizers include, but are not limited to, sodium hydroxide, triethanol amine, monoethanol amine, buffers, or other compounds that adjusts the pH of the wash composition. Neutralizers may be present in the wash composition at an amount of from about 0 to about 5 weight percent in some embodiments, based on the total weight of the wash composition, but in other embodiments the neutralizer may be present in the wash composition at an amount of from about 0 to about 3 weight percent, or an amount of from about 0 to about 2 weight percent, based on the total weight of the wash composition.

Optical brighteners may optionally be included in the wash composition. Optical brighteners adsorb ultraviolet and/or violet light and re-transmit it as visible light, typically a visible blue light. Optical brighteners include, but are not limited to, derivatives of diaminostilbene disulfonic acid or the alkali metal salts thereof. Suitable compounds are, for example, salts of 4,4′-bis(2-anilino-4-morpholino-1,3,5-triazinyl-6-amino)stilbene 2,2′-disulfonic acid or compounds of similar structure which, instead of the morpholino group, bear a diethanolamino group, a methylamino group, an anilino group or a 2-methoxyethylamino group. Optical brighteners of the substituted diphenylstyryl type may furthermore be present, such as the alkali metal salts of 4,4′-bis(2-sulfostyryl)diphenyl, 4,4′-bis(4-chloro-3-sulfostyryl)diphenyl, or 4-(4-chlorostyryl)-4′-(2-sulfostyryl)diphenyl. Mixtures of the above-stated optical brighteners may also be used. Optical brighteners may be present in the wash composition at an amount of from about 0 to about 1 weight percent in some embodiments, but in other embodiments optical brighteners are present in an amount of from about 0.01 to about 0.5 weight percent, or an amount of from about 0.05 to about 0.3 weight percent, or an amount of from 0.005 to about 5 weight percent, based on the total weight of the wash composition.

Foam inhibitors may also optionally be included in the wash composition. Suitable foam inhibitors include, but are not limited to, soaps of natural or synthetic origin, which include an elevated proportion of C₁₈-C₂₄ fatty acids. Suitable non-surfactant foam inhibitors are, for example, organopolysiloxanes and mixtures thereof with microfine, optionally silanized silica as well as paraffins, waxes, microcrystalline waxes and mixtures thereof with silanized silica or bis-fatty acid alkylenediamides. Mixtures of different foam inhibitors may also be used, for example mixtures of silicones, paraffins or waxes. In an exemplary embodiment, mixtures of paraffins and bistearylethylenediamide may be used. The wash composition may include the foam inhibitor at an amount of from about 0 to about 5 weight percent, but in other embodiments the foam inhibitor may be present at an amount of from about 0.05 to about 3 weight percent, or an amount of from about 0.5 to about 2 weight percent, based on the total weight of the wash composition.

Chelators bind and remove calcium, magnesium, or other metals from water, and may optionally be included in the wash composition. Many compounds can be used as water softeners, including but not limited to ethylenediaminetetraacetic acid (EDTA), nitrilotriacetic acid, diethylenetriaminepenta(methylenephosphonic acid), nitrilotris(methylenephosphonic acid), 1-hydroxyethane-1,1-diphosphonic acid, iminodisuccinic acid (IDS), or other chelating agents. Chelators may be present in the wash composition at an amount of from about 0 to about 5 weight percent in an exemplary embodiment, but in alternate embodiments the chelators are present at an amount of from about 0.01 to about 3 weight percent or an amount of from about 0.02 to about 1 weight percent, based on the total weight of the wash composition.

Bittering agents may optionally be added to hinder accidental ingestion of the single dose pack or the wash composition. Bittering agents are compositions that taste bad, so children or others are discouraged from accidental ingestion. Exemplary bittering agents include denatonium benzoate, aloin, and others. Bittering agents may be present in the wash composition at an amount of from about 0 to about 1 weight percent, or an amount of from about 0 to about 0.5 weight percent, or an amount of from about 0 to about 0.1 weight percent in various embodiments, based on the total weight of the wash composition.

The components of the wash composition are combined and mixed together with a mixer. Once mixed, the wash composition is encapsulated in the container, as described above. The components of the wash composition may all be mixed at one time, or different components may be pre-mixed and then combined. A wide variety of mixers may be used in alternate embodiments, such as an agitator, an in-line mixer, a ribbon blender, an emulsifier, and others. The wash composition is placed in a container, and then the film of the container is sealed with a sealer, where the sealer may utilize heat, water, ultrasonic techniques, water and heat, pressure, or other techniques for sealing the container and forming the single dose pack.

Another exemplary embodiment is also directed to the use of a single dose pack as described above in a cleaning process such as laundry and/or hard surface cleaning. In particular, an embodiment is directed to the use of a single dose pack in laundering of textile and fabrics, such as house-hold laundry washing and industrial laundry washing. A further exemplary embodiment is directed to the use of a single dose pack in hard surface cleaning such as automated Dish Washing (ADW), car washing, and the cleaning of industrial surfaces.

The fabrics and/or garments subjected to a washing, cleaning or textile care processes contemplated herein may be conventional washable laundry, such as household laundry. In some embodiments, the major part of the laundry is garments and fabrics, including but not limited to knits, woven fabrics, denims, non-woven fabrics, felts, yarns, and toweling. The fabrics may be cellulose based such as natural cellulosics, including cotton, flax, linen, jute, ramie, sisal or coir or manmade cellulosics (e.g., originating from wood pulp) including viscose/rayon, ramie, cellulose acetate fibers (tricell), lyocell or blends thereof. The fabrics may also be non-cellulose based such as natural polyamides including wool, camel, cashmere, mohair, rabbit, and silk, or the fabric may be a synthetic polymer such as nylon, aramid, polyester, acrylic, polypropylene and spandex/elastin, or blends of any of the above-mentioned products. Examples of blends are blends of cotton and/or rayon/viscose with one or more companion material such as wool, synthetic fibers (e.g., polyamide fibers, acrylic fibers, polyester fibers, polyvinyl alcohol fibers, polyvinyl chloride fibers, polyurethane fibers, polyurea fibers, aramid fibers), and cellulose-containing fibers (e.g., rayon/viscose, ramie, flax, linen, jute, cellulose acetate fibers, lyocell).

In one embodiment, the fabrics and/or garments are added to a washing machine, and the single dose pack is also added to the washing machine before wash water is added. In an alternate embodiment, the single dose pack may be added to an automatic detergent addition system of a washing machine, where the contents of the single dose pack are added to the wash water with the fabrics and/or garments after the washing process has begun. In yet another embodiment, the single dose pack is manually added to the fabrics and/or garments with the wash water after the washing process has started. The film dissolves and releases the wash composition into the aqueous wash water. The film is dissolved and washes out of the washing machine with the excess wash water, so there is nothing to collect from the fabrics and/or garments after the wash cycle. The fabrics and/or garments are laundered with the wash water and the contents of the single dose pack. The fabrics and/or garments may then be dried and processed as normal.

In an alternate embodiment, the single dose pack is added to a detergent charging system for an automatic dish washing machine. The detergent charging system opens and releases the single dose pack to the wash water and a main compartment of the dish washing machine at a designated point in the wash cycle.

### ILLUSTRATIVE EXAMPLES

The present disclosure is now illustrated by the following non-limiting examples. It should be noted that various changes and modifications can be applied to the following examples and processes without departing from the scope of this disclosure, which is defined in the appended claims. Therefore, it should be noted that the following examples should be interpreted as illustrative only and not limiting in any sense.

Eight different Example wash compositions, suitable for use in a single dose pack, were prepared according to the foregoing description. The eight Examples differ primarily on the included amounts of the non-aqueous solvents PEI-EO polymer and/or PEG 400 polymer. Examples 1 and 2 are comparative and include amounts of only one of PEI-EO polymer and PEG 400 polymer, respectively. Examples 3, 4, and 5 are inventive, and include combinations of the PEI-EO polymer and PEG 400 polymer in different amounts and ratios. Examples 6 and 7 are comparative similar to Examples 1 and 2, except including relatively less of the respective non-aqueous solvent polymer. Example 8 is also comparative and includes neither of the PEI-EO polymer or the PEG 400 polymer. The complete formulation for Examples 1 through 8 is set forth in TABLE 1, below:

TABLE 1

| Ingredient (wt.- %) | Ex. 1 | Ex. 2 | Ex. 3 | Ex. 4 | Ex. 5 | Ex. 6 | Ex. 7 | Ex. 8 |
|---|---|---|---|---|---|---|---|---|
| Alcohol Ethoxylate | 23.1 | 23.1 | 23.1 | 23.1 | 23.1 | 23.1 | 23.1 | 23.1 |
| Alkyl ether sulfate | 15.6 | 15.6 | 15.6 | 15.6 | 15.6 | 15.6 | 15.6 | 15.6 |
| Alkyl Benzene | 4.8 | 4.8 | 4.8 | 4.8 | 4.8 | 4.8 | 4.8 | 4.8 |
| Sulfonic Acid | | | | | | | | |
| Palm Kernel | 10.0 | 10.0 | 10.0 | 10.0 | 10.0 | 10.0 | 10.0 | 10.0 |
| Fatty Acid | | | | | | | | |
| PEI-EO Polymer | 4.5 | 0.0 | 1.0 | 2.0 | 3.0 | 2.0 | 0.0 | 0.0 |
| PEG 400 Polymer | 0.0 | 6.8 | 4.9 | 3.0 | 1.7 | 0.0 | 3.0 | 0.0 |
| Sodium Sulfite | 0.2 | 0.2 | 0.2 | 0.2 | 0.2 | 0.2 | 0.2 | 0.2 |
| Monethanolamine | 3.2 | 3.2 | 3.2 | 3.2 | 3.2 | 3.2 | 3.2 | 3.2 |
| Bittering Agent | 0.05 | 0.05 | 0.05 | 0.05 | 0.05 | 0.05 | 0.05 | 0.05 |
| Propylene Glycol | 8.2 | 8.2 | 8.2 | 8.2 | 8.2 | 8.2 | 8.2 | 8.2 |
| Glycerine | 12.9 | 10.6 | 11.5 | 12.4 | 12.7 | 15.4 | 14.4 | 17.4 |
| Water | 13.4 | 13.4 | 13.4 | 13.4 | 13.4 | 13.4 | 13.4 | 13.4 |

Each Example wash composition was diluted in water, first in a weight ratio of wash composition to water of 2:1, and second in a weight ratio of 1:1. The viscosity (25° C.) was analyzed for each of the diluted wash compositions. The results of this analysis are presented in TABLE 2, below. Moreover, with respect to the 2:1 dilution ratio, viscosity values for each of Examples 1-8, across a range of shear rates, are illustrated in the Drawing.

TABLE 2

| Dilution | | | | | | | | |
|---|---|---|---|---|---|---|---|---|
| Rheology | | | | | | | | |
| Results | Ex. 1 | Ex. 2 | Ex. 3 | Ex. 4 | Ex. 5 | Ex. 6 | Ex. 7 | Ex. 8 |
| Viscosity | 542 | 486 | 485 | 542 | 511 | 4457 | 154700 | 237000 |
| (Dilution | | | | | | | | |
| Ratio | | | | | | | | |
| 2:1; cps) | | | | | | | | |
| Viscosity | 381 | 268 | 295 | 339 | 380 | 367 | 332 | 2631 |
| (Dilution | | | | | | | | |
| Ratio | | | | | | | | |
| 1:1; cps) | | | | | | | | |

As shown from TABLES 1 and 2, and the Drawing, comparative Example 1 including 4.5 wt.-% PEI-EO polymer alone and comparative Example 2 including 6.8 wt. % PEG 400 polymer alone in the tested wash composition are able to reduce the viscosity of both the 2:1 and the 1:1 diluted solution to be below the desired level of 1,000 cps. It was also shown that Example 6 with a lower level of PEI-EO polymer alone or Example 7 with a lower level of PEG 400 polymer alone were not able to control viscosity of the 2:1 dilution solution to be below 1000 cps. Moreover, comparing Example 2 to Example 1, it is shown that the amount of the PEG 400 polymer required to replace or substitute with the PEI-EO polymer in order to successfully control the viscosities of the 2:1 and 1:1 ratio diluted wash compositions (i.e., the “conversion ratio”) is 6.8%: 4.5%, or a weight ratio of about 1.51:1.

Turning now to the inventive Examples 3 through 5, it is shown in TABLES 1 and 2 that each inventive Example was able to control the viscosity of the 2:1 and the 1:1 diluted wash compositions to be below the desired level of 1,000 cps. According, when comparing inventive Examples 3 through 5 with comparative Example 1, the ratio of added PEG 400 polymer amount to the reduced/replaced PEI-EO polymer amount (relative to the PEI-EO polymer amount in Example 1) are as follows: 4.9%:(4.5%-1%); 3%:(4.5%-2%); and 1.7%:(4.5%-3%) respectively (i.e., 1.4:1, 1.2:1, and 1.13:1, respectively). These ratios are lower compared to the “conversion ratio” of required PEG 400 polymer amount to completely replace the PEI-EO polymer, that is, about 1.51:1, as noted above.

As such, due to the lowered conversion ratio when used in combination, it can be concluded from the above ratio analysis that PEG 400 polymer and PEI-EO polymer exhibit a synergistic effect when used as non-aqueous solvents in a single dose pack wash composition on reducing dilution viscosity. Therefore, using both the PEG 400 polymer and the PEI-EO polymer allows for a significant reduction in the amount of total non-aqueous solvent polymer as compared with what would be required to achieve a similar effect if each polymer were used alone.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the subject matter in any way. Rather, the foregoing detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A single dose pack comprising:
a container, wherein the container comprises a water-soluble film; and
a wash composition encapsulated within the container, wherein the wash composition comprises:
a detergent surfactant;
water present in an amount of from about 5 to about 40 weight percent, based on the total weight of the wash composition; and
a non-aqueous solvent comprising a combination of a polyethylene glycol (PEG) polymer having a weight average molecular weight of from about 200 Daltons to about 1,000 Daltons and a polyethyleneimine-ethoxylated (PEI-EO) polymer,
wherein the non-aqueous solvent combination of the PEG and PEI-EO polymers is present in an amount of from about 1 to about 15 weight percent, based on the total weight of the wash composition, and
wherein a weight ratio of the PEG polymer to the PEI-EO polymer is from about 10:1 to about 1:10.

2. The single dose pack of claim 1, wherein the PEG polymer has a weight average molecular weight of from about 300 Daltons to about 800 Daltons.

3. The single dose pack of claim 2, wherein the PEG polymer has a weight average molecular weight of from about 300 Daltons to about 600 Daltons.

4. The single dose pack of claim 1, wherein the PEI-EO polymer comprises a polyethyleneimine backbone that has a weight average molecular weight of from about 400 Daltons to about 10,000 Daltons and polyoxyethylene chain substitution on the polyethyleneimine backbone having an average of about 40 to about 90 ethoxy units.

5. The single dose pack of claim 4, wherein the PEI-EO polymer comprises a polyethyleneimine backbone that has a weight average molecular weight of from about 400 Daltons to about 6,000 Daltons and polyoxyethylene chain substitution on the polyethyleneimine backbone having an average of about 45 to about 80 ethoxy units.

6. The single dose pack of claim 1, wherein the non-aqueous solvent combination of the PEG and PEI-EO polymers is present in an amount of from about 2 to about 13 weight percent, based on the total weight of the wash composition.

7. The single dose pack of claim 6, wherein the non-aqueous solvent combination of the PEG and PEI-EO polymers is present in an amount of from about 3 to about 10 weight percent, based on the total weight of the wash composition.

8. The single dose pack of claim 1, wherein the weight ratio of the PEG polymer to the PEI-EO polymer is from about 8:1 to about 1:8.

9. The single dose pack of claim 8, wherein the weight ratio of the PEG polymer to the PEI-EO polymer is from about 5:1 to about 1:5.

10. The single dose pack of claim 1, wherein the water present in an amount of from about 8 to about 30 weight percent, based on the total weight of the wash composition.

11. The single dose pack of claim 10, wherein the water present in an amount of from about 10 to about 25 weight percent, based on the total weight of the wash composition.

12. The single dose pack of claim 1, wherein the detergent surfactant comprises an ionic surfactant, and wherein the ionic detergent surfactant is present in an amount of from about 5 to about 55 weight percent, based on the total weight of the wash composition.

13. The single dose pack of claim 1, wherein the detergent surfactant comprises a nonionic surfactant, and wherein the nonionic detergent surfactant is present in an amount of from about 5 to about 50 weight percent, based on the total weight of the wash composition.

14. The single dose pack of claim 1, wherein the water-soluble film comprises a polyvinyl alcohol (PVOH).

15. The single dose pack of claim 1, further comprising one or more additional components selected from the group consisting of: enzymes, peroxy compounds, bleach activators, anti-redeposition agents, neutralizers, optical brighteners, foam inhibitors, chelators, bittering agents, dye transfer inhibitors, soil release agents, water softeners, electrolytes, pH regulators, graying inhibitors, anti-crease components, bleach agents, colorants, scents, processing aids, antimicrobial agents, and preservatives.

16. The single dose pack of claim 1, wherein the single dose pack is configured for use in a laundry washing machine or a dishwashing machine.

17. A single dose pack comprising:
a container, wherein the container comprises a water-soluble film; and
a wash composition encapsulated within the container, wherein the wash composition comprises:
a detergent surfactant;
water present in an amount of from about 8 to about 30 weight percent, based on the total weight of the wash composition; and
a non-aqueous solvent comprising a combination of a polyethylene glycol (PEG) polymer having a weight average molecular weight of from about 300 Daltons to about 800 Daltons and a polyethyleneimine-ethoxylated (PEI-EO) polymer that comprises a polyethyleneimine backbone that has a weight average molecular weight of from about 400 Daltons to about 10,000 Daltons and polyoxyethylene chain substitution on the polyethyleneimine backbone having an average of about 40 to about 90 ethoxy units,
wherein the non-aqueous solvent combination of the PEG and PEI-EO polymers is present in an amount of from about 2 to about 13 weight percent, based on the total weight of the wash composition, and
wherein a weight ratio of the PEG polymer to the PEI-EO polymer is from about 8:1 to about 1:8.

18. The single dose pack of claim 17, wherein the PEG polymer has a weight average molecular weight of from about 300 Daltons to about 600 Daltons.

19. The single dose pack of claim 17, wherein the weight ratio of the PEG polymer to the PEI-EO polymer is from about 5:1 to about 1:5.

20. A single dose pack configured for use in a laundry washing machine comprising:
a container, wherein the container comprises a water-soluble film; and
a wash composition encapsulated within the container, wherein the wash composition comprises:
a detergent surfactant comprising one or more ionic or nonionic surfactants;
water present in an amount of from about 10 to about 25 weight percent, based on the total weight of the wash composition; and
a non-aqueous solvent comprising a combination of a polyethylene glycol (PEG) polymer having a weight average molecular weight of from about 300 Daltons to about 600 Daltons and a polyethyleneimine-ethoxylated (PEI-EO) polymer that comprises a polyethyleneimine backbone that has a weight average molecular weight of from about 400 Daltons to about 6,000 Daltons and polyoxyethylene chain substitution on the polyethyleneimine backbone having an average of about 45 to about 80 ethoxy units,
wherein the non-aqueous solvent combination of the PEG and PEI-EO polymers is present in an amount of from about 3 to about 10 weight percent, based on the total weight of the wash composition, and
wherein a weight ratio of the PEG polymer to the PEI-EO polymer is from about 5:1 to about 1:5.
